(19) United States
(12) Patent Application Publication
(10) Pub. No.: US 2016/0171742 A1
(43) Pub. Date: Jun. 16, 2016

(54) METHOD AND DEVICE FOR ROTATING A MULTIDIMENSIONAL SPACE

(71) Applicant: ALCATEL LUCENT, Boulogne-Billancourt (FR)

(72) Inventors: Maarten Aerts, Beveren-Waas (BE); Sammy Lievens, Brasschaat (BE); Vinay Namboodiri, Leuven (BE); Donny Tytgat, Sint-Amandsberg (BE)

(73) Assignee: Alcatel Lucent, Boulogne Billancourt (FR)

(21) Appl. No.: 14/903,654

(22) PCT Filed: Jul. 7, 2014
(86) PCT No.: PCT/EP2014/064393

§ 371 Date: Jan. 8, 2016

(30) Foreign Application Priority Data
Jul. 9, 2013 (EP) 13305972.5

(51) Int. Cl. G06T 15/00; G06T 3/60

(52) U.S. Cl. CPC G06T 15/00; G06T 3/60

(57) ABSTRACT

Embodiments relates to a method for rotating a multidimensional space and a device for rotating a multidimensional space. The method may comprise:—obtaining (S1) 2D coordinates of a first point (p₁) and a second point (p₂) of a 2D visualization space input by a user,—determining (S2) a first D-dimensional vector (p₁) and a second D-dimensional vector (p₂) by projecting said first point (p₁) and said second point (p₂) into a D-dimensional space, wherein D is equal to or greater than 4,—determining (S3) a rotation matrix (R) in function of said first D-dimensional vector (p₁) and said second D-dimensional vector (p₂). The D-dimensional space has a first dimension, a second dimension and D-2 other dimensions, and the 2D visualization space has D-2 predefined regions associated with respective dimensions among said D-2 other dimensions. The method may comprise projecting (S2b) said 2D coordinates on said first dimension, said second dimension and, among the D-2 other dimensions, mostly on a third dimension associated with the region wherein at least one of the first point (p₁) and the second point (p₂) is located.

### FIELD OF THE INVENTION

The present invention relates to the field of user interface. In particular, the present invention relates to a method and a device for rotating a multidimensional space.

### BACKGROUND

Visualizing multidimensional data is hard, because a typical user interface renders in two, at most three dimensions at once. Any higher dimension is physically impossible to render, unless projecting it on a lower 2D or 3D visualization space. Even harder is navigating through the high dimensional space. Navigating is the process of defining a good projection from this high dimensional space to the 2D or 3D visualization space, using some input device. It requires a mapping of the limited degrees of freedom of the input device onto the degrees of freedom of that projection.

There are known solutions for navigating through 3D data, in particular for rotating 3D data. For example, a 3D trackball is an input device comprising a 3D sphere which can be rotated by the user. A rotation of the sphere can be mapped to a rotation of the 3D data. For a 2D input device such a mouse or a touchpad, a virtual trackball may be used. A virtual trackball is an imaginary sphere in the 3D space. A user may define a rotation of the data by rotating this sphere as if the mouse pointer, when clicked, is attached to a point on the sphere. Moving the mouse will cause the sphere, and thus the data, to rotate around its centre. Note that this sphere is not always imaginary: it may be drawn onto the screen as well.

However, there is no convenient solution for rotating higher dimensional spaces, such as 4D spaces or more.

### SUMMARY

It is thus an object of embodiments of the present invention to propose a method and a device for rotating a multidimensional space, which do not show the inherent shortcomings of the prior art.

Accordingly, embodiments relate to a method for rotating a multidimensional space, executed by a device for rotating a multidimensional space, comprising:
obtaining 2D coordinates of a first point and a second point of a 2D visualization space input by a user,
determining a first D-dimensional vector and a second D-dimensional vector by projecting said first point and said second point into a D-dimensional space, wherein D is equal to or greater than 4,
determining a rotation matrix in function of said first D-dimensional vector and said second D-dimensional vector,
   wherein said D-dimensional space has a first dimension, a second dimension and D-2 other dimensions, and the 2D visualization space has D-2 predefined regions associated with respective dimensions among said D-2 other dimensions, and
   wherein determining said first D-dimensional vector and said second D-dimensional vector comprises:
determining one of the regions specified by the user, and
projecting said 2D coordinates on said first dimension, said second dimension and, among the D-2 other dimensions, mostly on a third dimension associated with the region specified by the user.

Correlatively, embodiments relate to a device for rotating a multidimensional space, comprising:
means for obtaining 2D coordinates of a first point and a second point of a 2D visualization space input by a user,
means for determining a first D-dimensional vector and a second D-dimensional vector by projecting said first point and said second point into a D-dimensional space, wherein D is equal to or greater than 4,
means for determining a rotation matrix in function of said first D-dimensional vector and said second D-dimensional vector,
   wherein said D-dimensional space has a first dimension, a second dimension and D-2 other dimensions, and the 2D visualization space has D-2 predefined regions associated with respective dimensions among said D-2 other dimensions, and
   wherein the means for determining said first D-dimensional vector and said second D-dimensional vector comprise:
means for determining one of the regions specified by the user, and
means for projecting said 2D coordinates on said first dimension, said second dimension and, among the D-2 other dimensions, mostly on a third dimension associated with the region specified by the user.

The method may comprise displaying, in the 2D visualization space, a projection of the D-dimensional space rotated according to the rotation matrix.

The region specified by the user may be the region wherein at least one of the first point and the second point is located.

The regions may comprise an inner circle and D-3 annular rings centered on an origin of the 2D visualization space, defined by D-2 predetermined distances.

Determining the region specified by the user may comprise determining a distance from the origin of the 2D visualization space in function of the 2D coordinates of at least one of the first point and the second point.

The 2D coordinates may be projected only on the third dimension among the D-2 other dimensions.

The method may comprise displaying the regions in the 2D visualization space.

Determining the rotation matrix may comprise:
determining a singular value decomposition of a matrix composed of said first D-dimensional vector and said second D-dimensional vector,
determining a static hyperplane in function of said singular value decomposition, and
determining a rotation matrix for rotating the D-dimensional space along the static hyperplane.

The third dimension may be associated with the region wherein the second point is located.

The device may comprise a 2D input interface.

Embodiments also relate to a computer program including instructions adapted to perform said method for rotating a multidimensional space when said program is executed by a computer.

### BRIEF DESCRIPTION OF THE DRAWINGS

The above and other objects and features of the invention will become more apparent and the invention itself will be best understood by referring to the following description of embodiments taken in conjunction with the accompanying drawings wherein:

FIG. 1 shows a 2D visualization space of a user interface for displaying multidimensional data,

FIG. 2 is a flowchart of a method for rotating a multidimensional space,

FIG. 3 is a graph of functions which may be used in the method of FIG. 2, and

FIG. 4 is a structural view of a device for rotating a multidimensional space.

### DESCRIPTION OF EMBODIMENTS

It is to be remarked that the functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Their function may be carried out through the operation of program logic, through dedicated logic, through the interaction of program control and dedicated logic, or even manually, the particular technique being selectable by the implementer as more specifically understood from the context.

It should be further appreciated by those skilled in the art that any block diagrams herein represent conceptual views of illustrative circuitry embodying the principles of the invention. Similarly, it will be appreciated that any flow charts represents various processes which may be substantially represented in computer readable medium and so executed by a computer or processor, whether or not such computer or processor is explicitly shown.

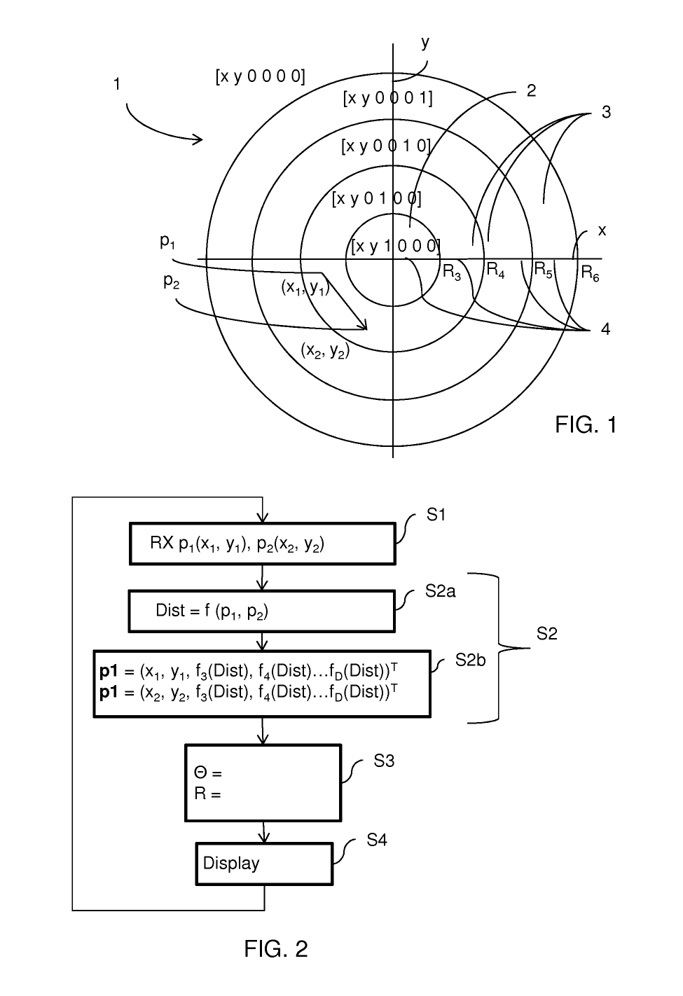

FIG. 1 shows a 2D visualization space 1 for displaying multidimensional data. The 2D visualization space 1 is displayed on a display interface 54 of a terminal 5 such as a screen. The terminal 5 comprises a 2D input device 53, for example a mouse, a touchpad or similar. The 2D visualization space 1 has a coordinate system comprising an axis x, an axis y and an origin O. A point pᵢ of the 2D display space 1 can be specified by its 2D coordinates (xᵢ, yᵢ).

D-dimensional data, wherein D is equal to or greater than 4, is projected for display on the 2D visualization space 1. The skilled person is aware of techniques for projecting multidimensional data onto a 2D visualization space and this will not be described in detail.

A D-dimensional virtual trackball allows rotating the D-dimensional space around its origin for changing its projections onto the 2D visualization space 1. The D-dimensional virtual trackball comprises an inner sphere of radius R₃, and D-3 outer shells of increasing radius R_{d}, with d ranging from 4 to D. The inner sphere and the outer shells are centered on the origin of the D-dimensional space.

In the 2D visualization space 1, the D-dimensional virtual trackball corresponds to D-2 regions: an inner circle 2 of radius R₃, and D-3 rings 3 delimited by radius R_{d-1} around the origin O (with d ranging from 4 to D). The increasing distances R₃ to R_{D} define a set of successive distance intervals 4: from 0 to R₃, from R₃ to R₄ . . . from R_{D-1} to R_{D}. Each of the regions corresponds to one of the distance intervals. The distance from the origin O of point pᵢ of the 2D visualization space 1 is comprised in the distance interval corresponding to the region (that is the inner circle 2 or one of the rings 3) wherein pᵢis located.

Note that the inner circle 2 and the rings 3 may be displayed in the 2D visualization space 1, as illustrated in FIG. 1 for the example of D=6. Alternatively, the circle 2 and rings 3 needs not be displayed.

By using the 2D input device 53 for interacting with the D-dimensional virtual trackball, the user of the terminal 5 may rotate the D-dimensional space around its origin, as described hereafter with reference to FIG. 2. For this, the user specifies a first point p₁ a second point p₂ of the 2D visualization space 1. For example, the user moves a pointer by using a mouse while holding a mouse button, and p₁ and p₂ are two successive positions of the pointer.

Depending on the region wherein p₁ and p₂ are located, the D-dimensional space is rotated in another subset of dimensions: The inner circle 2 behaves similarly to a 3D virtual trackball and corresponds to a rotation in the first three dimensions XYZ of the D-dimensional space. The second ring 3 (corresponding to distance interval from R₃ to R₄) correspond to a rotation in the first, second and fourth dimension. The third ring 3 (corresponding to distance interval from R₄ to R₅) correspond to a rotation in the first, second and fifth dimension and so on.

By always defining rotations including the first two dimensions of the D-dimensional space, the interaction with the mouse pointer looks more intuitive than with any other combination. Moreover, a rotation in any other combination of dimensions may be decomposed in a sequence of rotations including the first two dimensions and another one. Also, this split feels intuitive. The resulting rotation always lays in a hyperplane. This means that all points rotate in parallel hyperplanes around the center with a constant angle to another point in the same hyperplane. In 3D this is the only type of rotation possible. In 4D, it is called a ‘simple’ rotation, a small subset of all possible rotations. But by only scoping this type of rotations, the user feels he has some control of the interaction, making it more predictive.

In another embodiment, the regions associated with the D-2 dimensions have a different shape than the inner circle 2 and annular rings 3, for example an elliptic shape or a sector shape.

FIG. 2 is a flowchart of a method for rotating the D-dimensional space, executed by the terminal 5.

Initially, the user inputs the 2D coordinates (x₁, y₁) of a first point p₁ and (x₂, y₂) of a second point p₂ (step S1). For example, as explained previously, the user moves a pointer by using a mouse while holding a mouse button, and p₁ and p₂ are two successive positions of the pointer.

Then, the terminal 5 determines two vectors p₁ and p₂, in the D-dimensional space, by projecting the positions of the points p₁ and p₂ from the 2D visualization space 1 to the D-dimensional space (step S2). Note that this projection is the opposite of the projection mentioned above (from the D-dimensional space to the 2D visualization space 1) and could be referred to as a back projection or reversed projection.

For this, the terminal 5 determines a region specified by the user (step S2a). In this embodiment, this region is the region wherein the point p₂ is located. Thus, the terminal 5 determines the distance Dist between the origin O and point p₂: Dist=\sqrt{x₂²+y₂²}. Since p₁ and p₂ are close to each other, in another example the region may be the region wherein the point p₁ or an intermediate point between p₁ and p₂, for example the middle point between p₁ and p₂, is located. In that case, the distance Dist is calculated accordingly. In another example, the region specified by the user is the region of the initial mouse down event, even for successive pairs of points p₁ and p₂ located outside this region. In that case, the vectors p₁ and p₂ are determined for successive pairs of points p₁ and p₂, but the region remains the same.

In the example of the regions (inner circle 2 and rings 3) of FIG. 1, the distance Dist is comprised in the distance interval 4 corresponding to the region wherein p₂ (or another point as explained before) is located.

Then, the terminal 5 determines the two vectors p₁ and p₂ by projecting the 2D coordinates of the points p₁ and p₂ on three dimensions of the D-dimensional space: Two predetermined dimensions and, among the remaining D-2 other dimensions, a third dimensions which depends on the distance Dist (step S2b). The two predetermined dimensions may be the two first dimensions X and Y. The third dimension is the dimension associated with the region wherein the point p₂ is located. This can be expressed as follows:

p₁=(x₁, y₁, f₃(Dist), f₄(Dist), . . . , f_{D}(Dist))^{T}

p₂=(x₂, y₂, f₃ (Dist), f₄(Dist), . . . , f_{D}(Dist))^{T}

wherein:

$${f}_{d} ( Dist ) = \{ \begin{matrix}1 & if {R}_{d - 1} < Dist < {R}_{d} \\ 0 & otherwise\end{matrix}$$

The function f_{d} is equal to 1 when the point p₂ is located in the inner circle 2 or the ring 3 corresponding to the dimension d, and 0 otherwise. This choice poses hard boundaries at the circle with radius R_{d} between the rings 3. A smoother transition may be obtained by using a “softer function”, that is a continuous function f_{d} which is above a threshold t₀ for a distance Dist between R_{d-1} and R_{d}, and below the threshold t₀ otherwise, preferably below a lower threshold t₀ further away from the interval [R_{d-1}, R_{d}]. For example:

$${f}_{d} ( Dist ) = \frac{1}{2} tanh ( \frac{Dist - {R}_{d - 1}}{0.2} ) - \frac{1}{2} tanh ( \frac{Dist - {R}_{d}}{0.2} )$$

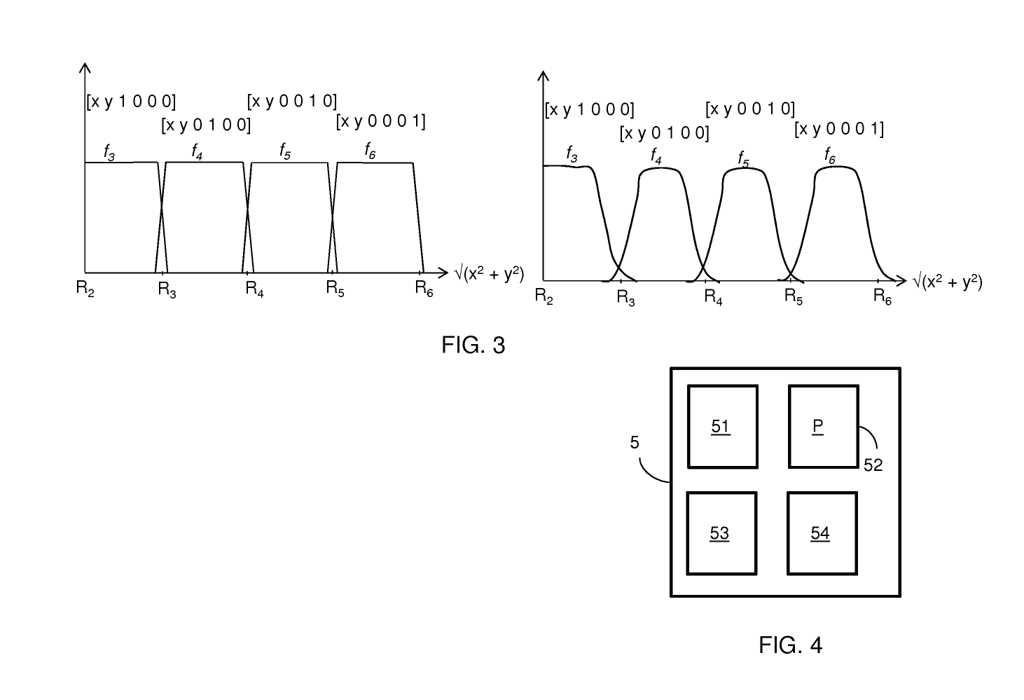

The functions f_{d} in both cases are illustrated in the graphs of FIG. 3, for D=6. In the first case (left of FIG. 3), the 2D coordinates of the points p₁ and p₂ are projected on the X and Y dimensions and exclusively on a third dimension which depends on the region wherein p₂ is located. In the second case (right of FIG. 3), the 2D coordinates of the points p₁ and p₂ are projected on the X and Y axis and mostly (but not exclusively) on a third dimension which depends on the region wherein p₂ is located.

In this embodiment wherein the regions associated with the D-2 dimensions are delimited by circles, is it possible to determine the region wherein the point p₂ is located in function of the distance Dist and the distances R_{d}. In an embodiment wherein the regions associated with the D-2 dimensions are not delimited by circles, for example they have an elliptic or sector shape, the region wherein the point p₂ is located may be determined for example by using functions f_{d} which varies according to both x₂ and y₂.

Then, the terminal 5 determines a rotation matrix R in function of the vectors p₁ and p₂ (step S3). The person skilled in the art is capable of determining a rotation matrix R in function of two vectors in various manners.

In one example, since rotation is not about an axis, but about several at once, the terminal 5 determines a static hyperplane (v₁, v₂) along which the points are rotated. The complementary hyperspace (v₃ . . . v_{D}) forms the set of rotation axes. These spaces are defined from the Singular Value Decomposition of the matrix [p₁ p_{2]:}

[p1 p2]=UΣV^{T}

wherein V=(v₁ v₂ . . . V_{D}).

Then, a rotation angle θ is determined:

$$θ = {cos}^{- 1} ( \frac{{p}_{1} \cdot {p}_{2}}{‖ {p}_{1} ‖ \cdot ‖ {p}_{2} ‖} )$$

The rotation matrix R may be calculated from the rotation angle θ and the matrix V as follows:

R=cos θI_{D*D}+sin θ(v₁v₂^{T}−v₂v₁^{T)+(}1−cos θ)Σ_{d=3}^{D}v_{d}v_{d}^{T}

wherein I_{D*D} is the identity matrix of dimension D.

Then, the terminal 5 projects the D-dimensional space rotated according to the rotation matrix R and the rotation angle θ to the 2D visualization space 1, and displays the 2D visualization space 1 (step S4).

Steps S1 to S4 may be repeated for the next pair of successive points p₁ and p₂. Thus, the user may have the impression of holding the D-dimensional virtual trackball with the mouse pointer and rotating the D-dimensional space according to the rotation of the D-dimensional virtual trackball.

It can be noted that the method of FIG. 2 does not take into account the data of the D-dimensional space. Thus, this is a generic method based on the user's input, which may apply independently of the data.

The method for rotating multidimensional data described here may be used in various examples.

In a first example, a user wants to browse through a media collection. All media objects are rated for each of the following genres: drama, comedy, thriller, action, horror, fantasy and science-fiction. As a result, the media all have a 7-dimensional feature descriptor with each dimension corresponding to its genre rating. The media objects are visualized as a 3D point cloud on a 2D screen. The closest points to the viewer are drawn with a title and a small screenshot. The size corresponds to how close the 3D point is to the user. Far away points are discarded or drawn as small dots. Note that these 3D points are somehow a projection of the original 7D space. A user can influence the projection directions by rotating the 7D point cloud using a 7D virtual trackball as described above. The ring-shaped regions of the trackball may be drawn in a subtle manner in the background of the screen. A user may bring e.g. comedy movies to the front or send thrillers to the back by dragging the trackball accordingly. Similarly the user may create a drama versus action plot by rotating the point cloud. Note that the projection directions do not have to align exactly with the genres. Combinations are possible too.

Other examples of multidimensional data include booking sites for hotels, restaurant guides, online shops . . . Websites offering such data reduce browsing to filtering and sorting. Often up to a 1D list or a 2D map. This reduces the possibilities of the user, who feels constraint and needs to perform multiple searches with different filter and sort settings to get a complete overview (which may only exist in his head, as the constraint view doesn't allow the preferential overview). The D-dimensional virtual trackball described here allows the user to browse the data collection in all dimensions at once with a single interface.

High dimensional data is also available in many scientific branches. Meteorologists for instance want to visualize air pressure and wind speed, which is adding one or two dimensions on top of the four dimensions of space-time. Browsing through such data is constraint by the limits of the input controller, often a 2D mouse pointer. This means the scientist has to continuously switch between different tools or input modes in order to visualize the data in the way he wants. This is time consuming and the constraints may even disable the possibility of a preferential visualization, which makes the scientist miss important conclusions. Other scientific branches include astronomy, statistical analysis, quantum physics . . .

FIG. 4 is structural view of the terminal 5. The terminal 5 comprises a processor 51, a memory 52, the 2D input interface 53 and the display interface 54. The processor 51 allows executing computer programs stored in the memory 52. The steps of the methods of FIG. 2 may correspond to the execution of such a computer program P. In this embodiment, the terminal 5 is an example of device for rotating multidimensional data.

In another embodiment, which may be referred to as a client/server embodiment, the terminal 5 sends data representative of the positions of the points p₁ and p₂ to a server, which may perform some of the steps of FIG. 2. For example, the server receives the coordinates of the points p₁ and p₂, determines the vectors p₁ and p₂, the rotation matrix R and the rotation angle θ and sends back the rotation matrix R and the rotation angle θ to the terminal 5.

Embodiments of the method can be performed by means of dedicated hardware and/of software or any combination of both.

While the principles of the invention have been described above in connection with specific embodiments, it is to be clearly understood that this description is made only by way of example and not as a limitation on the scope of the invention, as defined in the appended claims.

1. Method for rotating a multidimensional space, executed by a device for rotating a multidimensional space, comprising:
obtaining 2D coordinates of a first point and a second point of a 2D visualization space input by a user,
determining a first D-dimensional vector and a second D-dimensional vector by projecting said first point and said second point into a D-dimensional space, wherein D is equal to or greater than 4,
determining a rotation matrix in function of said first D-dimensional vector and said second D-dimensional vector,
wherein said D-dimensional space has a first dimension, a second dimension and D-2 other dimensions, and the 2D visualization space has D-2 predefined regions associated with respective dimensions among said D-2 other dimensions, wherein said regions comprise an inner circle and D-3 annular rings centered on an origin of the 2D visualization space, defined by D-2 predetermined distances, and
wherein determining said first D-dimensional vector and said second D-dimensional vector comprises:
determining one of the regions specified by the user, and
projecting the 2D coordinates of the first point and the second point on said first dimension, said second dimension and, among the D-2 other dimensions, on a third dimension associated with the region specified by the user.

2. Method according to claim 1, comprising displaying, in the 2D visualization space, a projection of the D-dimensional space rotated according to the rotation matrix.

3. Method according to claim 1, wherein the region specified by the user is the region wherein at least one of the first point and the second point is located.

4. Method according to claim 1, wherein determining one of the regions specified by the user comprises determining a distance from the origin of said 2D visualization space in function of the 2D coordinates of at least one of said first point and said second point.

5. Method according to claim 1, wherein the 2D coordinates of the first point and the second point are projected only on said third dimension among the D-2 other dimensions.

6. Method according to claim 1, comprising displaying said regions in the 2D visualization space.

7. Method according to claim 1, wherein said determining said rotation matrix comprises:
determining a singular value decomposition of a matrix composed of said first D-dimensional vector and said second D-dimensional vector,
determining a static hyperplane in function of said singular value decomposition, and
determining a rotation matrix (R) for rotating the D-dimensional space along the static hyperplane.

8. Method according to claim 1, wherein the region specified by the user is the region wherein the second point is located.

9. Device for rotating a multidimensional space, comprising:
means for obtaining 2D coordinates of a first point and a second point of a 2D visualization space input by a user,
means for determining a first D-dimensional vector and a second D-dimensional vector by projecting said first point and said second point into a D-dimensional space, wherein D is equal to or greater than 4,
means for determining a rotation matrix in function of said first D-dimensional vector and said second D-dimensional vector,
wherein said D-dimensional space has a first dimension, a second dimension and D-2 other dimensions, and the 2D visualization space has D-2 predefined regions associated with respective dimensions among said D-2 other dimensions, wherein said regions comprise an inner circle and D-3 annular rings centered on an origin of the 2D visualization space, defined by D-2 predetermined distances, and
wherein said means for determining said first D-dimensional vector and said second D-dimensional vector comprise:
means for determining one of the regions specified by the user, and
means for projecting the 2D coordinates of the first point and the second point on said first dimension, said second dimension and, among the D-2 other dimensions, on a third dimension associated with the region specified by the user.

10. Device according to claim 9, comprising a 2D input interface.

11. Computer program including instructions adapted to perform the method according to claim 1 when said program is executed by a computer.
